(19) United States
(12) Patent Application Publication
(10) Pub. No.: US 2015/0115058 A1
(43) Pub. Date: Apr. 30, 2015

(54) SPRAYER NOZZLE SYSTEM FOR VARIABLE APPLICATION RATES

(71) Applicant: Wilfred H. Wilger, Saskatoon (CA)

(72) Inventor: Wilfred H. Wilger, Saskatoon (CA)

(21) Appl. No.: 14/067,600

(22) Filed: Oct. 30, 2013

(51) Int. Cl. A01G 25/16; A01G 25/09

(52) U.S. Cl. CPC A01G 25/165; A01G 25/09
USPC 239/61

(57) ABSTRACT

In a sprayer nozzle apparatus a pressurized liquid source directs pressurized liquid through a supply conduit and a supply port connects the supply conduit to first and second nozzles oriented such that spray patterns dispensed thereby do not intersect. First and second pressure sensors send pressure signals to a controller indicating first and second operating pressures at the nozzles. First and second pressure regulators vary the corresponding operating pressures in response to a control signals received from the controller to vary the dispensing rate of the first and second nozzles.

This invention is in the field of sprayers, such as for example agricultural sprayers, and in particular such a sprayer with a nozzle mounting and control system which conveniently provides an extended range of application rates which can be varied during operation.

### BACKGROUND

There are many applications where it is necessary to spray a fluid material onto a target surface, often the ground. This application is notable for example in agriculture, horticulture and such things as golf course maintenance and pest control where chemicals are mixed with water and then sprayed on the ground, on plants growing from the ground, on bodies of water, and the like. Various fluids must also often be sprayed on roadways and other surfaces as well.

Spraying is accomplished with sprayers, either self-propelled or towed units, and with aerial sprayers mounted on airplanes or helicopters. Such sprayers commonly comprise a tank of fluid, a pump for pressurizing and distributing the fluid to spray nozzles and means to control the fluid pressure. Sprayers typically have a plurality of nozzle bodies, each securing a spray nozzle, mounted on booms which swing in for transport and out for operation. Airplane mounted sprayers typically have a boom fixed to the wings.

The nozzle locations are spaced apart on a boom, perpendicular to the direction of travel, at a standard spacing distance which corresponds to the spray pattern of the nozzles. The same size nozzle is in operating position at each nozzle location, providing a consistent application rate across the width of the sprayer. The most common spray pattern is a flat-fan pattern, and the nozzles are generally rotated approximately 10 degrees from being perpendicular to the direction of travel in order that the overlapping spray patterns do not intersect and interfere with each other.

The booms may be of the “wet boom” type, where the boom comprises a frame member with a pipe mounted thereon, the fluid passing through the pipe into nozzles mounted on the pipe and fluidly connected thereto, or a “dry boom” type, where the nozzles are mounted to the frame member and fluid passes to the nozzles through a hose which is connected between the nozzles. The “boom” then is the structure upon which the nozzles are mounted, fluid passing directly through the “wet boom”, and fluid passing through a separate hose to nozzles mounted on a “dry boom”. A pump delivers the fluid to the nozzles, the fluid pressure being controlled by a pressure regulating valve.

Such sprayers must accurately dispense the fluid over the desired area of target surface. Historically this has been accomplished by providing a spray nozzle having a set operating pressure such that when operated at that pressure, the nozzle accurately dispensed a known amount of fluid per time unit. Operating the sprayer at a known speed then accurately resulted in the correct amount of fluid being dispensed over a given area, however as the speed increased or decreased the application rate increased or decreased accordingly.

To help overcome this problem, “extended range” nozzles were developed which maintained an accurate distribution across the width of the spray pattern at a range of pressures from approximately 20 psi to 60 psi. If the operator wants to spray at an increased or decreased speed, he increases or decreases the pressure to maintain the desired application rate. Such extended range nozzles provide satisfactory spray patterns over a range of about 30% above or below a mid-point rate, however where larger rate changes are required, a nozzle change is required.

Rate controllers became available as well which measure the total flow of fluid along the boom to the nozzles and automatically vary the pressure as the speed varies, maintaining a total flow to the nozzles that will maintain a stable application rate along the boom as speed varies. These rate controllers can also be used to vary the application rate by maintaining a constant speed, and varying the pressure. Variable application rates have become desirable with the advent of field mapping, where different areas of a field are best treated with different rates of the particular liquid being applied.

Modern agriculture/horticulture sprayers typically have a boom with multiple spray sections that can be independently controlled. Usually a master control means is used to control the entire boom, while each section may have its own control or switch. Liquid pressure in each section can be varied by a rate controller to apply different rates to field portions passed over by each section, and flow to any section can be stopped completely if desired.

External location and guidance systems utilizing Global Positioning Satellites (GPS), local broadcasting towers, and the like have allowed sprayers to be located and also guided precisely, and also provide precision control of application rates and avoidance of spray overlap as described for example in U.S. Pat. Nos. 6,522,948 and 6,877,675 to Benneweis.

Considerable precision in the controls is desirable, as discussed in U.S. Pat. No. 8,352,130 to Mitchell which provides a system for anticipating a change in the ground speed of the spraying vehicle such that a lag that otherwise would occur in the rate of product input delivered is reduced.

An externally guided spraying system is also described in U.S. Pat. No. 7,124,964 to Bui which discloses a flexible, self-adjusting flow nozzle where the self-adjusting capability of the spray nozzle enables the creation of an automatic spray system that includes a computerized controller that receives inputs pertaining to vehicle speed, geographic vehicle position, and flow rate and/or fluid pressure which are compared against a predetermined flow plan for a given field and the controller automatically adjusts the flow rate to the nozzles accordingly.

U.S. Pat. No. 7,395,769 to Jensen discloses a farm implement for applying a product to a row crop or a row seeded field wherein the implement has a plurality of spaced-apart product dispensers, such as spray nozzle, seed dispensers, and the like, where each of dispenser is individually automatically controlled by an external guidance system. The application rate of each dispenser is adjusted to compensate for the different ground speeds encountered during turns, and also to vary application rates according a field map indicating desired application rates for different field areas. Achieving a wide range of smoothly transitioning application rates with current spray nozzles is, however, problematic.

U.S. Pat. No. 6,126,088 to the present inventor Wilger discloses a nozzle mounting and control system for use in sprayers comprising multiple nozzles mounted in the operating position on a sprayer boom such that 2, 3, or more nozzles pass over the same target surface. Wide ranges of application rates are achieved by control valves operable to select which nozzles are open and operating at any given time. The valves may be remote controlled and may further incorporate a rate controller to maintain a chosen application rate by opening and closing appropriate valves as the sprayer speed varies, and/or by varying the pressure in the conduits supplying the nozzles.

### SUMMARY OF THE INVENTION

The present disclosure provides a sprayer nozzle apparatus that overcomes problems in the prior art.

In a first embodiment the present disclosure provides a sprayer nozzle apparatus comprising a pressurized liquid source directing a flow of liquid at a selected supply pressure through a supply conduit. A supply port connects the supply conduit to corresponding first and second input ports of first and second nozzles, and the first and second nozzles are oriented in corresponding first and second operating positions such that a first spray pattern dispensed by the first nozzle does not intersect a second spray pattern dispensed by the second nozzle. A first pressure sensor sends a first pressure signal to a controller indicating a first operating pressure at the first input port and a second pressure sensor sends a second pressure signal to the controller indicating a second operating pressure at the second input port. A first pressure regulator is operative to vary the first operating pressure in response to a first control signal received from the controller to vary a dispensing rate of the first nozzle, and a second pressure regulator is operative to vary the second operating pressure in response to a second control signal received from the controller to vary a dispensing rate of the second nozzle.

In a second embodiment the present disclosure provides a spraying implement comprising a vehicle mounted on wheels for movement along the ground in an operating travel direction, and a spray boom extending laterally from the vehicle substantially perpendicular to the operating travel direction. A pressurized liquid source directs a flow of liquid at a selected supply pressure along the spray boom through a supply conduit, and a plurality of sprayer nozzle apparatuses are substantially equally spaced along the boom, each sprayer nozzle apparatus comprising first and second nozzles oriented in corresponding first and second operating positions such that a first spray pattern dispensed by the first nozzle does not intersect a second spray pattern dispensed by the second nozzle. For each sprayer nozzle apparatus, a supply port connects the supply conduit to corresponding first and second input ports of the first and second nozzles.

Each sprayer nozzle apparatus comprises a first pressure sensor sending a first pressure signal to a controller indicating a first operating pressure at the input port of the first nozzle and a second pressure sensor sending a second pressure signal to the controller indicating a second operating pressure at the input port of the second nozzle, and a first pressure regulator operative to vary the first operating pressure in response to a first control signal received from the controller to vary a dispensing rate of the first nozzle, and a second pressure regulator selectively operative to vary the second operating pressure in response to a second control signal received from the controller to vary a dispensing rate of the second nozzle. The controller receives location signals from an external guidance system, calculates a travel speed of each sprayer nozzle apparatus, and sends control signals to vary the operating pressure at each input port to achieve a desired dispensing rate from each nozzle in each sprayer nozzle apparatus.

The sprayer nozzle apparatus provides a wide range of variable liquid dispensing rates suitable for use in sprayers controlled by an external guidance system to provide consistent application rates across the width of a sprayer boom, or to provide varying application rates across the width of the sprayer boom. Wind conditions can be addressed by operating different nozzles and/or by varying operating pressures to increase or decrease droplet size. A typical application of the disclosed sprayer nozzle apparatus is in agricultural field sprayers however the nozzle apparatus could be utilized in other applications in various industries as well.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic top view of an embodiment of a sprayer nozzle apparatus of the present disclosure;

FIG. 2 is a schematic sectional side view of the embodiment of FIG. 1;

FIG. 3 is a perspective view of an alternate embodiment of a sprayer nozzle apparatus of the present disclosure;

FIG. 4 is a schematic sectional side view of a nozzle body of the embodiment of FIG. 3;

FIG. 5 is a schematic exploded sectional side view of the nozzle body of FIG. 4;

FIG. 6 is a schematic top view of a spraying implement of the present disclosure;

FIG. 7 is a schematic bottom view of two alternate embodiments of a sprayer nozzle apparatus of the present disclosure connected to a supply conduit;

FIG. 8 is a schematic bottom view of the sprayer nozzle apparatus of FIG. 3 connected to a supply conduit;

FIG. 9 is a schematic bottom view of the sprayer nozzle apparatus connected to a supply conduit where the center of the apparatus is mounted under the conduit with the middle nozzle directly under the conduit′, and front and rear nozzles on opposite sides of the conduit.

### DETAILED DESCRIPTION OF THE ILLUSTRATED EMBODIMENTS

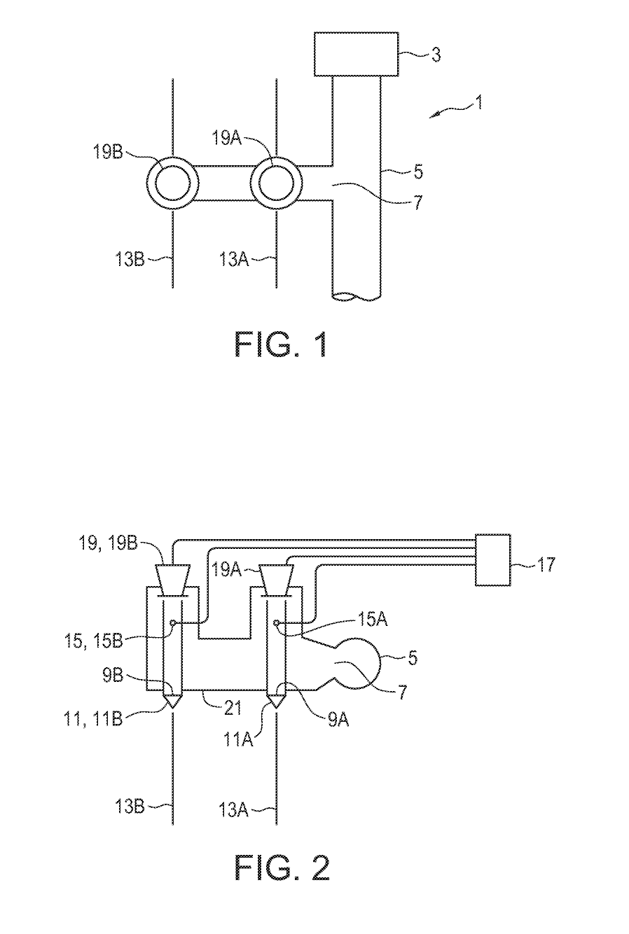

FIGS. 1 and 2 schematically illustrate an embodiment of a sprayer nozzle apparatus 1 of the present invention comprising a pressurized liquid source 3 directing a flow of liquid at a selected supply pressure through a supply conduit 5. A supply port 7 connects the supply conduit 5 to corresponding first and second input ports 9A, 9B of first and second nozzles 11A, 11B.

The first and second nozzles 11A, 11B are oriented in corresponding first and second operating positions as illustrated such that a first spray pattern 13A dispensed by the first nozzle 11A does not intersect a second spray pattern 13B dispensed by the second nozzle 11B so both patterns maintain their form and do not interfere with each other.

A first pressure sensor 15A sends a first pressure signal to a controller 17 indicating a first operating pressure at the first input port 9A and a second pressure sensor 15B sends a second pressure signal to the controller 17 indicating a second operating pressure at the second input port 9B. The controller 17 typically compares the current dispensing rates, which are known from the current pressures and the nozzle sizes, to the desired dispensing rates, and sends control signals back to adjust the pressures to corresponding target pressures which will achieve the desired dispensing rates.

A first pressure regulator 19A is operative to vary the first operating pressure in response to a first control signal received from the controller 17 to vary the dispensing rate of the first nozzle 11A, and a second pressure regulator 19B is operative to vary the second operating pressure in response to a second control signal received from the controller 17 to vary the dispensing rate of the second nozzle 11B. The pressure regulators 19 are selectively operative to vary the corresponding first and second operating pressures in a range between zero and the selected supply pressure that is present in the supply conduit 5.

In the schematically illustrated apparatus 1 of FIGS. 1 and 2 the nozzles 11 are mounted in a nozzle holding member 21 connected to the supply port 7, and the liquid flows through the nozzle holding member 21 and the pressure regulators 19 to each nozzle 11.

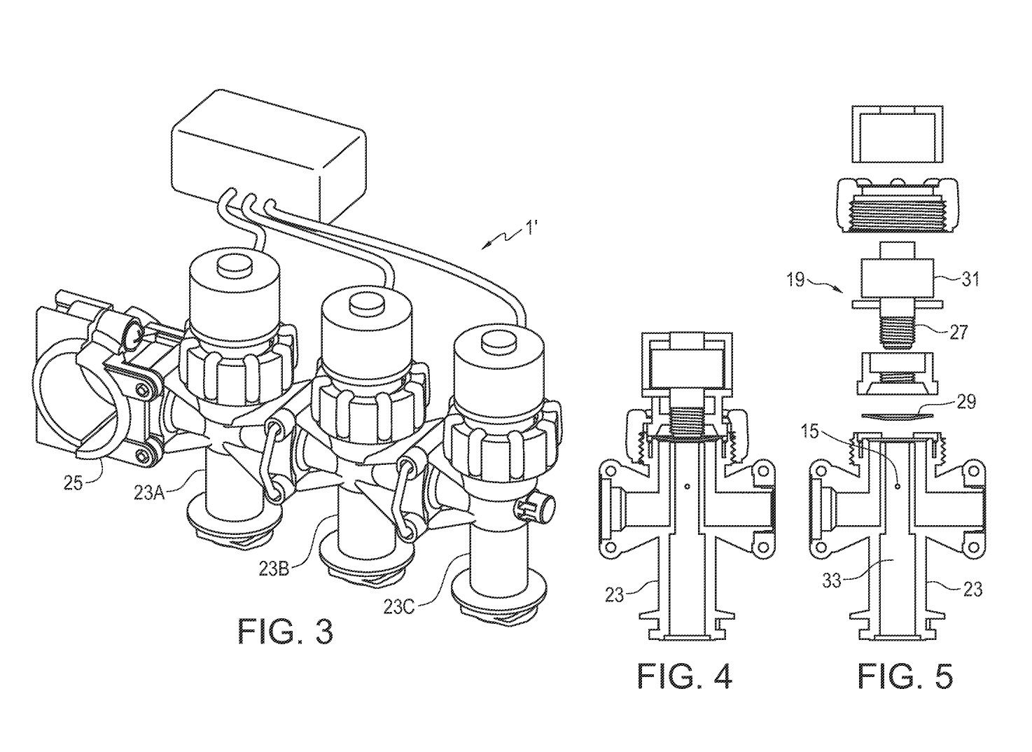

FIGS. 3-5 illustrate a versatile apparatus 1′ where each nozzle 11, and associated pressure sensor 15 and pressure regulator 19, is mounted in a separate nozzle body 23. A first nozzle body 23A is connected to the supply port and secured to the supply conduit with a clamp 25. A second nozzle body 23B is connected to the first nozzle body 23A, and a third nozzle body 23C is connected to the second nozzle body 23B. The liquid flows through the supply port to the first nozzle body 23A, through the first nozzle body 23A to the second nozzle body 23B, and through the second nozzle body 23B to the third nozzle body 23C. Selected nozzles 11 of different sizes and dispensing rates can be attached at lower ends of the nozzle bodies 23.

Thus nozzle bodies 23 and associated nozzles 11 can be added as required by any particular application, and readily replaced if a pressure sensor 15 or pressure regulator 19 fails. The nozzles 11 are oriented in operating positions such that the spray patterns do not intersect and so maintain their form and do not interfere with each other.

As schematically illustrated in FIGS. 4 and 5 the pressure regulators 19 comprise, as is known in the art, a pressure control valve with a rotating shaft 27 with a bottom end bearing against a diaphragm 29, and an actuator 31 operative to rotate the shaft 27 to move the diaphragm 29 up and down to vary the pressure of the liquid in the channel 33 under the diaphragm 29 carrying the liquid to a nozzle mounted on the bottom end of the nozzle body 23. Conveniently the actuator 29 can be provided by a stepper motor that will rotate the shaft 27 in steps.

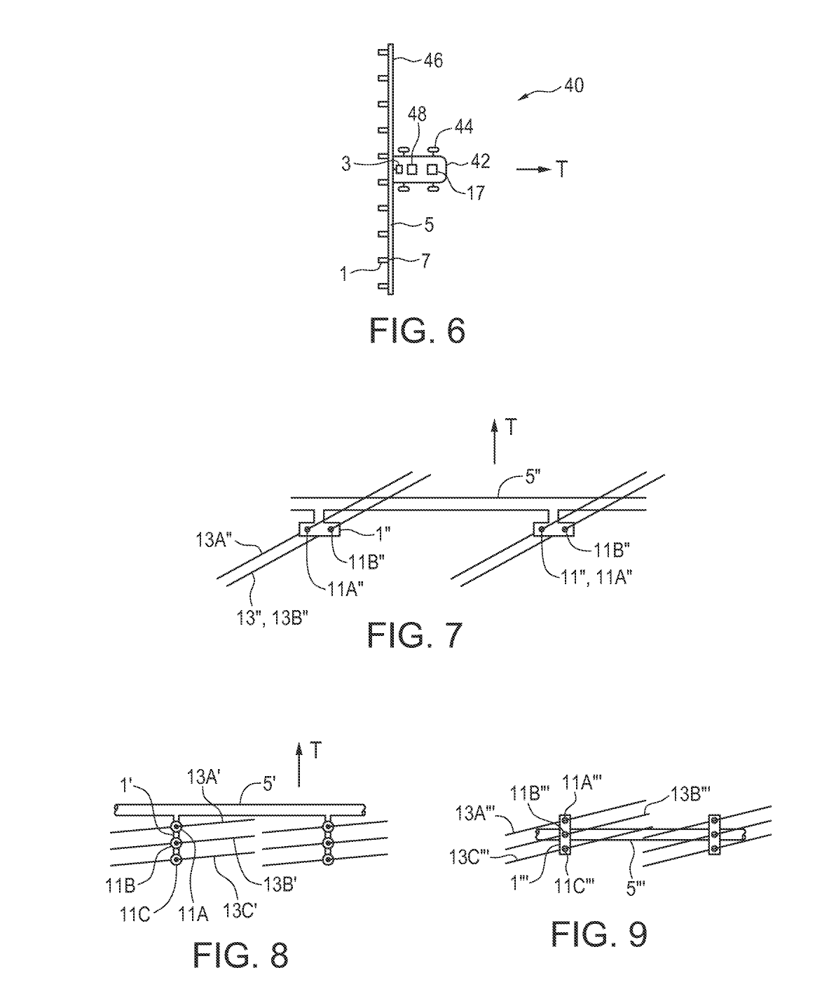

FIG. 6 schematically illustrates a spraying apparatus 40 comprising a vehicle 42 mounted on wheels 44 for movement along the ground in an operating travel direction T, such as would for example be used in a typical agricultural spraying application. A spray boom 46 extends laterally from the vehicle 42 substantially perpendicular to the operating travel direction T, and a pressurized liquid source 3 directs a flow of liquid at a selected supply pressure along the spray boom 46 through a supply conduit 5. A plurality of sprayer nozzle apparatuses 1, such as are illustrated in FIGS. 1 and 2, are equally spaced along the boom 46, each sprayer nozzle apparatus 1 connected to the supply conduit 5 through a supply port 7 and to a controller 17. The controller 17 receives location signals from an external guidance system 48, calculates a travel speed of each sprayer nozzle apparatus 1, and varies the operating pressure at each input port 9A, 9B to achieve a desired dispensing rate from each nozzle 11 in each sprayer nozzle apparatus 1.

Thus in the implement 40, the sprayer nozzle apparatuses 1 are equally spaced along the boom 46 and in each apparatus 1 the first nozzle 11A is forward of the second nozzle 11B such that the first and second spray patterns 13A, 13B spray substantially the same area of target surface as the vehicle moves in the operating travel direction T. Similarly the sprayer nozzle apparatus 1′ illustrated in FIG. 3 could be used, where the nozzles mounted in each of the nozzle bodies 23 are also aligned in the operating travel direction T, all spraying the same area of target surface.

Alternatively, in a sprayer nozzle apparatus 1″ mounted to the boom and connected to the supply conduit 5″, as schematically illustrated in a bottom view in FIG. 7, the first nozzle 11A″ is beside and in close proximity to the second nozzle 11W. The nozzles 11″ are oriented such that the flat fan spray patterns 13″ are at an angle with respect to the operating travel direction T so they do not intersect. In this arrangement the first and second spray patterns 13A″, 13W spray closely adjacent areas of target surface. When mounted along the sprayer boom, all first nozzles 11A″ of each sprayer nozzle apparatus 1″ are equally spaced along the spray boom, and second nozzles 11W of each sprayer nozzle apparatus 1″ are also equally spaced along the spray boom. The slight offset of the first and second nozzles 11A″, 11B″ will not be noticeable, given the width of the sprayer boom, which can be 100 or more feet wide.

Similarly FIG. 8 schematically illustrates a bottom view of the sprayer nozzle apparatus 1′ of FIGS. 3-5 mounted on a sprayer boom. In this arrangement the first, second, and third spray patterns 13A′, 13B′, and 13C′ of each apparatus 1′ are aligned in the operating travel direction T and so spray the same of target surface. The spray patterns 13′ of the nozzles 11′ in adjacent spray nozzle apparatuses 1′ can be tilted as in the prior art to avoid contact between the adjacent spray patterns. FIG. 9 schematic illustrates an alternate spray nozzle apparatus 1′″ where, instead of the nozzles extending in one direction from the conduit 5″ as shown in FIG. 8, the center of the apparatus 1′″ is mounted under the conduit 5′″ with the middle nozzle 11W′ under the conduit 5′″, and nozzle 11A′″ on one side of the conduit 5′″ and the other nozzle 11C″ on the opposite side of the conduit 5′″.

The two, three, or more nozzles 11 can be selected to provide a desired maximum application rate which would be equal to the sum of the dispensing rates of each nozzle at the maximum available pressure which will be equal to the selected supply pressure in the supply conduit 5. The pressure at each nozzle 11 is then individually controlled by the controller 17 in the range from zero to the supply pressure. Typically nozzles 11 with different sized dispensing orifices will be installed in each apparatus 1, 1′, 1″ to provide suitable application rates.

In many types of nozzles 11, a minimum operating pressure must be present in order to provide a satisfactory spray pattern 13. Where such nozzles 11 are used on the implement 40, a minimum application rate would be that rate dispensed by the nozzle with the lowest dispensing rate at the minimum operating pressure. Thus each sprayer nozzle apparatus 1, l′, 1″ could be changed from an off position where all operating pressures are zero and no liquid is dispensed, to the minimum application rate, and then continuously from the minimum application rate to the maximum application rate by turning selected ones of the nozzles off and on and varying the operating pressure at the nozzles.

The sprayer nozzle apparatus of the present disclosure can also be used to vary droplet size by installing nozzles with different drift reduction capabilities in the apparatus. When winds are higher or in drift sensitive areas, to achieve a desired application rate the controller operates the higher drift reduction nozzles which have a larger droplet size to reduce drift, and when winds are low, the controller achieves the same application rate by operating the nozzles with lower drift reduction which have a smaller droplet size and thus improved efficacy.

It is also known that a nozzle operating at a low pressure dispenses larger droplets than the same nozzle when operating at a high pressure. In windy conditions, the controller can be programmed to operate the nozzles at lower pressures. For example in an apparatus with three nozzles, operating two of the nozzle at a pressure of 50 pounds per square inch (psi) in low wind conditions may give the desired application rate, while operating all three nozzles at a pressure of 25 psi in high wind conditions may give the same desired application rate with bigger droplet size and reduced drift.

The disclosed sprayer nozzle apparatus provides a wide range of available liquid dispensing spray rates from a minimum rate to a maximum rate, and also an off position where no liquid is dispensed. The disclosed spraying implement can accurately dispense a varying amount of liquid at each nozzle location to provide a consistent application rate across the width of the sprayer boom during turns, and can also provide variable application rates at different locations across the width of the boom if desired.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A sprayer nozzle apparatus comprising:
a pressurized liquid source directing a flow of liquid at a selected supply pressure through a supply conduit;
a supply port connecting the supply conduit to corresponding first and second input ports of first and second nozzles;
wherein the first and second nozzles are oriented in corresponding first and second operating positions such that a first spray pattern dispensed by the first nozzle does not intersect a second spray pattern dispensed by the second nozzle;
a first pressure sensor sending a first pressure signal to a controller indicating a first operating pressure at the first input port and a second pressure sensor sending a second pressure signal to the controller indicating a second operating pressure at the second input port;
a first pressure regulator operative to vary the first operating pressure in response to a first control signal received from the controller to vary a dispensing rate of the first nozzle, and a second pressure regulator operative to vary the second operating pressure in response to a second control signal received from the controller to vary a dispensing rate of the second nozzle.

2. The apparatus of claim 1 wherein the first and second pressure regulators are selectively operative to vary the corresponding first and second operating pressures in a range between zero and the selected supply pressure.

3. The apparatus of claim 1 wherein the first and second nozzles are mounted in first and second nozzle bodies, and wherein the first nozzle body is connected to the supply port and the second nozzle body is connected to the first nozzle body, and wherein the liquid flows through the supply port to the first nozzle body and through the first nozzle body to the second nozzle body.

4. The apparatus of claim 1 wherein the first and second nozzles are mounted in a nozzle holding member connected to the supply port, and wherein the liquid flows through the nozzle holding member to each of the first and second nozzles.

5. The apparatus of claim 1 wherein the first pressure regulator comprises a pressure control valve with a rotating shaft, and an actuator operative to rotate the shaft to vary the first pressure.

6. The apparatus of claim 4 wherein the actuator is provided by a stepper motor.

7. The apparatus of claim 1 wherein the first and second nozzles are mounted on a vehicle for movement along the ground in an operating travel direction, and wherein the first nozzle is forward of the second nozzle, such that the first and second spray patterns spray substantially the same area of target surface.

8. The apparatus of claim 1 wherein the first and second nozzles are mounted on a vehicle for movement along the ground in an operating travel direction, and wherein the first nozzle is beside and in close proximity to the second nozzle such that the first and second spray patterns spray closely adjacent areas of ground surface.

9. The apparatus of claim 1 wherein the first and second nozzles are mounted on a vehicle for movement in an operating travel direction and wherein the controller receives location signals from an external guidance system, calculates a travel speed of the nozzles, and sends control signals to the first and second pressure regulators to vary the first and second pressures to achieve a desired dispensing rate from the first and second nozzles that corresponds to the travel speed.

10. The apparatus of claim 1 wherein the supply port connects the supply conduit to a third input port of a third nozzle oriented in a third operating position such that a third spray pattern dispensed by the third nozzle does not intersect the first and second spray patterns, and comprising a third pressure sensor sending a third pressure signal to the controller indicating a third operating pressure at the third input port, and a third pressure regulator operative to vary the third operating pressure in response to a third control signal received from the controller to vary a dispensing rate of the third nozzle.

11. A spraying implement comprising:
a vehicle mounted on wheels for movement along the ground in an operating travel direction;
a spray boom extending laterally from the vehicle substantially perpendicular to the operating travel direction;
a pressurized liquid source directing a flow of liquid at a selected supply pressure along the spray boom through a supply conduit;
a plurality of sprayer nozzle apparatuses substantially equally spaced along the boom, each sprayer nozzle apparatus comprising first and second nozzles oriented in corresponding first and second operating positions such that a first spray pattern dispensed by the first nozzle does not intersect a second spray pattern dispensed by the second nozzle;
for each sprayer nozzle apparatus, a supply port connecting the supply conduit to corresponding first and second input ports of the first and second nozzles;
wherein each sprayer nozzle apparatus comprises:
a first pressure sensor sending a first pressure signal to a controller indicating a first operating pressure at the input port of the first nozzle and a second pressure sensor sending a second pressure signal to the controller indicating a second operating pressure at the input port of the second nozzle; and
a first pressure regulator operative to vary the first operating pressure in response to a first control signal received from the controller to vary a dispensing rate of the first nozzle, and a second pressure regulator selectively operative to vary the second operating pressure in response to a second control signal received from the controller to vary a dispensing rate of the second nozzle;
wherein the controller receives location signals from an external guidance system, calculates a travel speed of each sprayer nozzle apparatus, and sends control signals to vary the operating pressure at each input port to achieve a desired dispensing rate from each nozzle in each sprayer nozzle apparatus.

12. The implement of claim 11 where first nozzles of each sprayer nozzle apparatus are substantially equally spaced along the spray boom, and second nozzles of each sprayer nozzle apparatus are substantially equally spaced along the spray boom.

13. The implement of claim 12 wherein the first nozzles are forward of the second nozzles such that the first and second spray patterns of each sprayer nozzle apparatus spray substantially the same area of ground surface.

14. The implement of claim 12 wherein the first nozzles are beside and in close proximity to the second nozzles such that the first and second spray patterns of each sprayer nozzle apparatus spray closely adjacent areas of ground surface.

15. The implement of claim 11 wherein each supply port connects the supply conduit to a third input port of a third nozzle of the spray nozzle assembly oriented in a third operating position such that a third spray pattern dispensed by the third nozzle does not intersect the first and second spray patterns, and comprising a third pressure sensor sending a third pressure signal to the controller indicating a third operating pressure at the third input port, and a third pressure regulator operative to vary the third operating pressure in response to a third control signal received from the controller to vary a dispensing rate of the third nozzle.

16. The implement of claim 15 wherein third nozzles of each sprayer nozzle apparatus are substantially equally spaced along the spray boom.
